(19) United States
(12) Patent Application Publication
(10) Pub. No.: US 2023/0148471 A1
(43) Pub. Date: May 18, 2023

(54) TRIMMER MOWER ROTOR

(71) Applicant: Windegger Maschinen GmbH, Lana (IT)

(72) Inventors: Martin WINDEGGER, Lana (IT); Walter WINDEGGER, Lana (IT)

(73) Assignee: Windegger Maschinen GmbH, Lana (IT)

(21) Appl. No.: 17/917,012

(22) PCT Filed: Apr. 16, 2021
(86) PCT No.: PCT/EP2021/059866

§ 371 Date: Oct. 5, 2022

(30) Foreign Application Priority Data
Apr. 22, 2020 (IT) 102020000008581

(51) Int. Cl. A01D 34/416; A01D 34/835

(52) U.S. Cl. CPC A01D 34/4162; A01D 34/835

(57) ABSTRACT

A trimmer mower rotor (100), formed by a receptacle (105) on which at least one plastic thread (103) is wound, wherein the receptacle is rotatably accommodated in a housing (101) and the receptacle (105) and the housing are rotatable about a single axis, wherein the housing (101) has at least one opening through which the at least one plastic thread (103) is passed to the outside. The receptacle (105) and the housing having the at least one opening rotate at different speeds.

### BACKGROUND OF THE INVENTION

The present invention relates to a trimmer mower rotor.

### TECHNICAL FIELD

The technical field is the thread trimming rotors, the so-called line thread brush cutter heads, used for mechanical trimming between the rows in orchards or other areas. The thread is a consumable used for trimming.

### STATE OF THE ART

EP 2092816 discloses a thread brush cutter head which is provided with a thread carrier rotary shaft for a series of elastic threads which tend to align radially under the effect of centrifugal force, and a protective cover. Threads are wound on the rotary thread carrier shaft inside a rotatable mounted tube or ends of said threads protruding axially through the bores or sleeves provided on said tube on the same shaft and the rotation of the tube relative to the coaxial shaft is controlled by a freewheel mechanism with a lockable or reversible direction of rotation.

From US 2005 076 515, a portable brush cutter head is known which has an improved tensioning mechanism for the thread used for cutting, trimming grass and the like. In this publication, a counter-rotating mechanism is described that allows the manual extraction of the thread if necessary.

From the publication WO 2014 083550, a module is known which comprises a drive shaft with a hexagonal cross-section which extends along a longitudinal axis. This device comprises a plurality of modules arranged around the shaft and coupled together in the axial direction, a plurality of anchors each coupled inside a respective motor of the shaft, and a plurality of working threads of which each is coupled to a respective anchorage, coiled within a respective motor and having two opposite ends protruding from the module. In use they are mutually axially engaged and rotate with the shaft for rotation.

From EP 3 138 376, a trimmer rotor is known which comprises a tubular shaft extending along the longitudinal axis, driven to rotate about the longitudinal axis and a cylindrical structure and a replaceable protective tube arranged around the cylindrical structure and configured to slide on the ground, having a plurality of working threads each disposed within the tube shaft and configured to pass two respective end portions through two respective openings in the cylinder wall outside the tube shaft.

From EP 3 056 075, a trimmer mower rotor is known, where the prior art cited there describes that the rotating element is connected to the housing and can be rotated in a second position relative to the housing in order to allow the thread to unwind.

This is only intended to allow the thread to unroll. In this phase, however, the rotor does not work, as can be seen from the paragraph, since the thread used during use is consumed and is thus restored. It can therefore be deduced that the unwinding does not take place during use.

From WO2016 120140, a trimmer mower rotor is known, in which the thread is replaced manually without opening it. With this rotor, too, it is necessary to interrupt the trimming process to replace the thread.

All of these devices have a significant problem that the working thread has to be pulled out during processing. This causes a considerable amount of work.

### SUMMARY OF THE INVENTION

In the present invention, “substantially” deviations of +−5% and/or +−5° are understood.

The object of the present invention is the design a trimmer mower rotor which has a continuous feeding of the line during the operation of the motor.

This object is achieved by a trimmer mower rotor having the features of the patent claims and a machine using a rotor according to the invention.

Proposed is a trimmer mower rotor formed by a receptacle on which at least one thread is wound, the receptacle being accommodated in a housing which has at least two openings through which two thread sections of a trimmer mower rotor are guided to the outside. According to the invention, the receptacle rotates about at least one part forming the housing at different speeds and preferably the receptacle rotates at a speed greater than the speed of a part of the housing in a direction opposite to the winding direction of the thread on the receptacle, wherein both parts are driven.

In this way, a continuous unwinding takes place. Advantageously, the housing rotates at 180.000 revolutions per hour and the receptacle rotates at 180.000 revolutions per hour +1 to 10 revolutions per hour.

In this way the thread is unwound at from 1 to 10 revolutions per hour.

Advantageously, the two parts are driven by a single drive, but with the interposition of a transmission.

Advantageously, the rotor rotates about a vertical axis with respect to the terrain/working plane.

In a further embodiment, a cutting element and/or a device with a cutting element is arranged at a predetermined distance which, when the thread exceeds a predetermined length, is cut off by the cutting element, wherein the device is advantageously collecting the portion of the cut of thread in order to avoid environmental pollution.

Advantageously, the thread receptacle is a replaceable element.

In a preferred embodiment, two threads are wound on the receptacle, each with an exiting end through the opening in the housing of the thread trimming rotor.

The rotor according to the invention is preferably arranged on a machine which is towed, for example, by a tractor or the like.

This machine preferably comprises four rotors according to the invention, which are arranged laterally in two pairs.

### DESCRIPTION OF THE DRAWINGS

Other characteristics and details of the invention appear from the patent claims and from the following description of a preferred, non-limiting embodiment shown in the attached drawings.

FIG. 1 is a perspective of a device according to the invention with rotors in the rest position;

FIG. 2 is a perspective of a device with rotors in working position;

FIG. 3 is a front view of a device according to the invention with rotors in resting position;

FIG. 4 is a front view of a device according to the invention with rotors in working position;

FIG. 5 is an enlarged sectional view of a rotor according of the invention;

FIG. 6 is an enlarged sectional view of a thread receptacle for a rotor according to the invention;

FIG. 7 is an enlarged perspective view of two rotors according to the invention driven by a single drive;

FIG. 8 is a sectional view of two rotors according to the invention driven by a single drive in a second embodiment;

FIG. 9 is a vertical view of FIG. 8;

FIG. 10 is a perspective view of FIG. 8;

FIG. 11 is a top perspective view of FIG. 8; FIG. 12 is a perspective of a device according to the invention with rotors in the rest position in a second embodiment;

FIG. 13 is a perspective view of the device of FIG. 12 in extended form;

FIG. 14 is a plan view of the device of FIG. 12 in retracted form;

FIG. 15 is a plan view of the device of FIG. 12 in extended form;

FIG. 16 is a sectional view of the device of FIG. 12;

FIG. 17 is a side view of a device according to the invention with the wheel resting on the ground; and

FIG. 18 is a side view of the device according to the invention with the wheel partially retracted/tilted.

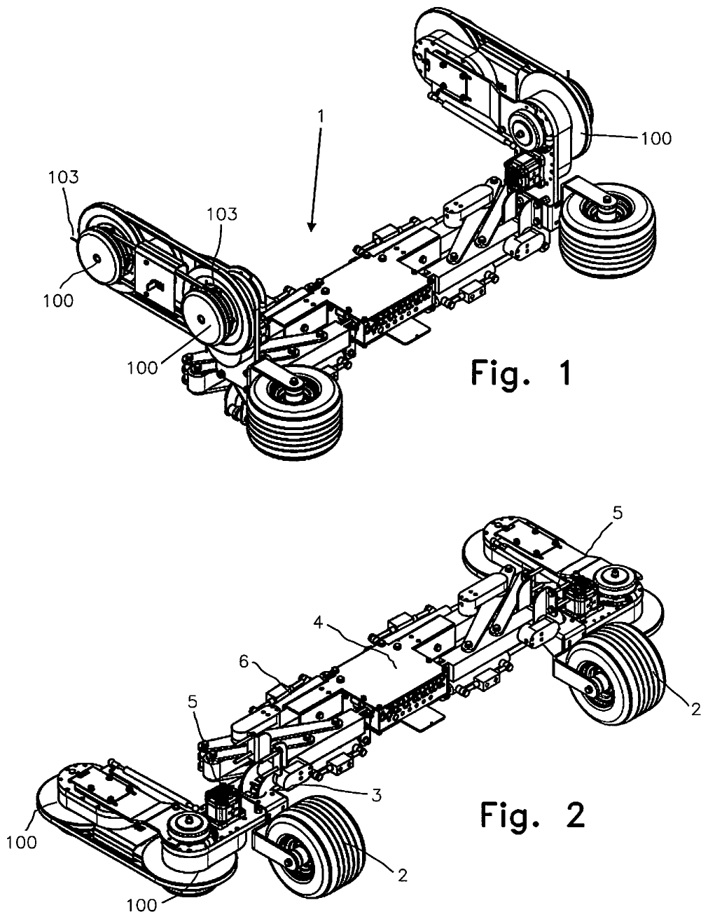

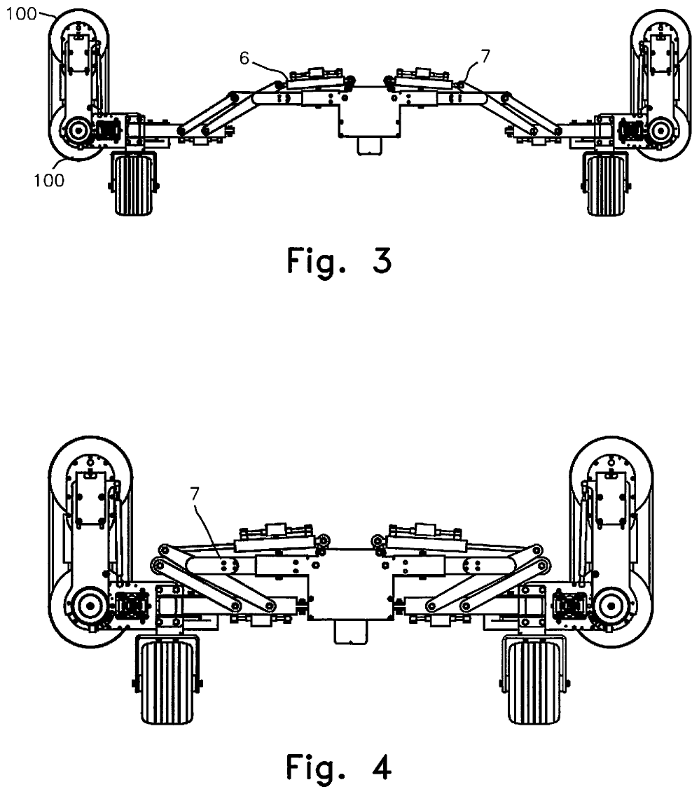

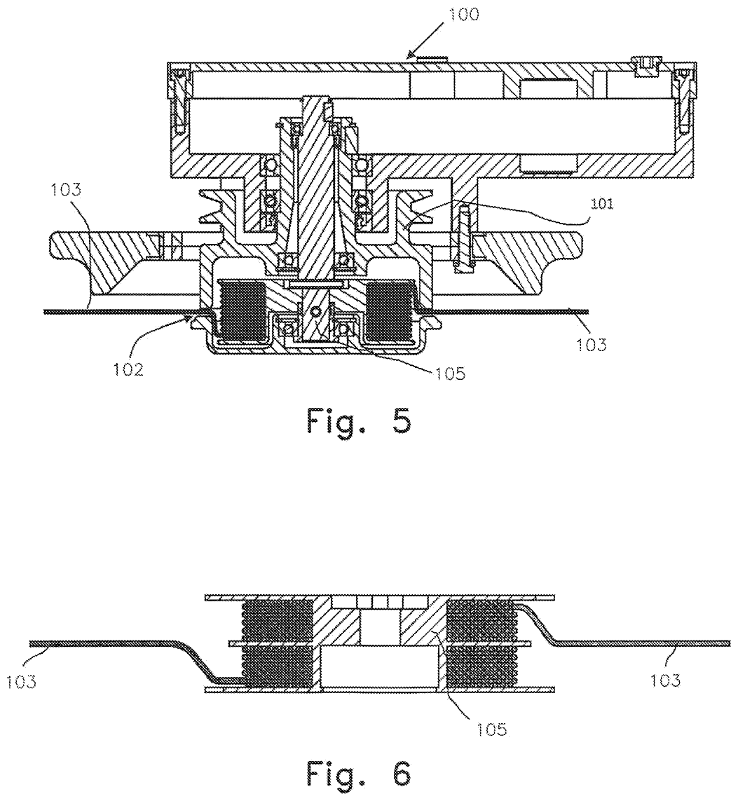

### DETAILED DESCRIPTION OF THE INVENTION

In FIG. 1, reference number 1 indicates a trimming device with a frame 4 to which two trimming rotors 100 are connected on two sides according to the invention. These rotors 100 are driven laterally by a drive. The drive 5 is advantageously an electric motor and/or hydraulic motor. The two rotors 100 are advantageously connected to the frame 4 of the device 1 by a connection point 3 that allows the device 1 to bend and therefore to reduce the width. Advantageously, the second, outermost trimming rotor 100 can be pivoted relative to the first trimming rotor about an axis that is essentially parallel to the axis of rotation of the trimmer rotor 100. The device 1 is advantageously pulled by a tractor (not shown) or the like, and the drives 5 are also powered by the pulling means. In a further embodiment, the entire system could also be driven by a hydraulic drive system. Advantageously, the device 1 according to the invention comprises 2 wheels that carry it. Advantageously, these wheels can also be used to shorten the dimensions of the device 1. Advantageously, the frame 4 of the device 1 has joints 7 which can be controlled by a piston system 6 in order to increase or decrease the width of the device 1. This is particularly advantageous because in this way the area to be trimmed can be adjusted depending on the actual situation. Since the distance between the rows often varies between the trees depending on the zone and terrain and that of trees, plants or other plantings, the trimming rotors 100 are advantageously connected to each other by a thread 103 which drives both trimming rotors laterally and is driven itself by the drive 5.

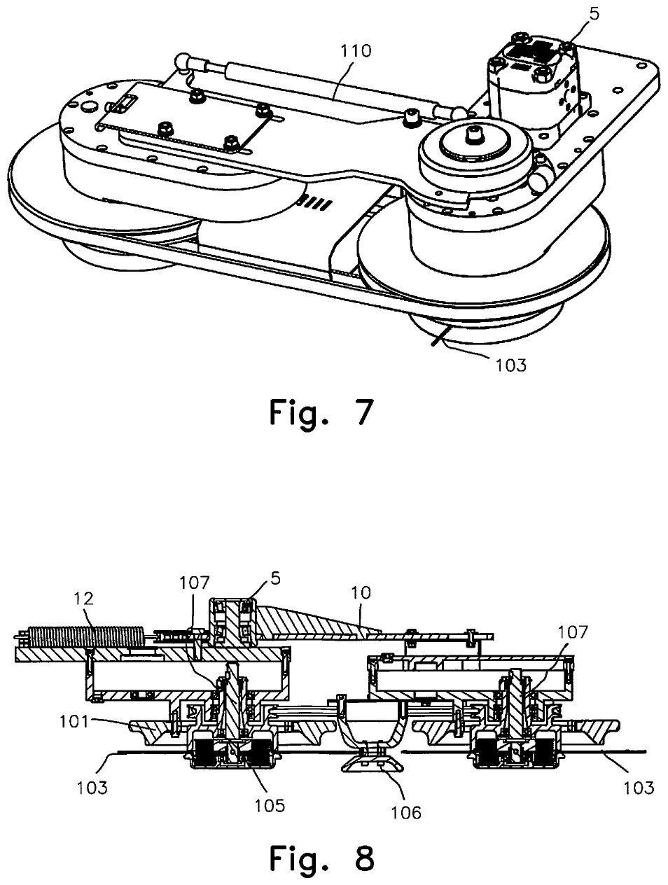

As illustrated in FIG. 7, the mowing rotor 100 is preferably mounted in pairs with another mowing rotor 100 on one side of a trimming device.

However, in one embodiment, the trimming rotor 100 according to the invention can also be carried individually by a person, for example on the shoulder, and driven by a motor, for example an internal combustion engine.

The trimming rotor 100 includes a receptacle 105 which is accommodated in a housing 101. At least one thread 103, preferably at least two threads 103, is/are wound up on top of one another on this receptacle 105. The receptacle 105 can be rotated relative to the housing 101. The housing preferably has a circular cross section. The receptacle 105 and the housing 101 can be rotated relative to a common axis of rotation. This axis of rotation is preferably perpendicular to the terrain when the trimming rotor 100 is in the operating position.

This housing 101 has openings 102, preferably at least two openings 102, which extend from the inside of the housing to the outside. Each thread sections 103 are guided to the outside via these openings 102. The two openings 102 are advantageously arranged on opposite sides of the housing 101.

As soon as the trimming rotor 100 is in operation, there is a speed difference between the receptacle 105 and the housing 101. Advantageously, the housing rotates at a speed that is less than the direction away from the un-winding direction of the thread 103 on the receptacle 105.

In this way, the thread 103 unrolls during operation of the trimming rotor 100. Advantageously, unwinding is limited to a few centimetres per minute, just the amount required to be consumed/worn during operation.

In this way, the thread is unwound continuously. Advantageously, the housing rotates at 180.000 revolutions per hour and the seat rotates at 180.000 revolutions per hour +1 to 10 revolutions per hour.

In this way the thread is unwound at from 1 to 10 revolutions per hour.

In an advantageous embodiment, by controlling the speed of the individual parts, i.e. receptacle 105 and housing 101, the unwinding speed of the thread can be regulated during the mowing process, e.g. via the transmission ratio or via the drives, which means that the unwinding speed of the thread can be changed during trimming.

The thread 103 used is a plastic thread.

The drive 5 advantageously drives a belt 8 which in turn drives two trimming rotors 100. The movement of the belt is transmitted through a transmission that adjusts the difference in speed between the housing 101 and the receptacle 105. The receptacle 105 is driven by a gear which is connected to the driven transmission by the belt 8. The receptacle 105 is preferably connected to a shaft 107, which is preferably firmly connected to the receptacle 105 by a separable and/or detachable connection, for example with a screw connection or the like.

The shaft 107 is preferably driven by a gear which is connected to the driven transmission by the belt 8. In this way, the receptacle 105 can be detached and inserted within the housing 101. The housing 101 can be closed by a cover at the bottom or opened towards the bottom so as to allow an easier replacement of the receptacle 105, wherein the receptacle 105 forming the bottom of the housing 101.

Advantageously, the receptacle 105 can be sold as an reload for the trimming rotor 100 according to the invention.

In this way, the reloading can be done quickly and accurately, while ensuring a predetermined unwinding since the thread winding of the plastic thread 103 was done under supervision.

In a preferred embodiment, the rotor and/or a cutting device 106 is connected to the device outside of the housing 101. This cutting device 106 is preferably arranged on the device 1 and is placed between two trimming rotors 100 according to the invention. In this way, the length of the thread 103 is adjusted. As soon as the thread exceeds a predetermined length due to the continuous unwinding, it hits the cutting device 106 during the rotation. In this way, the thread 103 is cut off by a cutting device, for example one or more knives arranged in the cutting device 106. The cutting device 106 is advantageously designed in such a way that the cut off thread 103 is collected in a container.

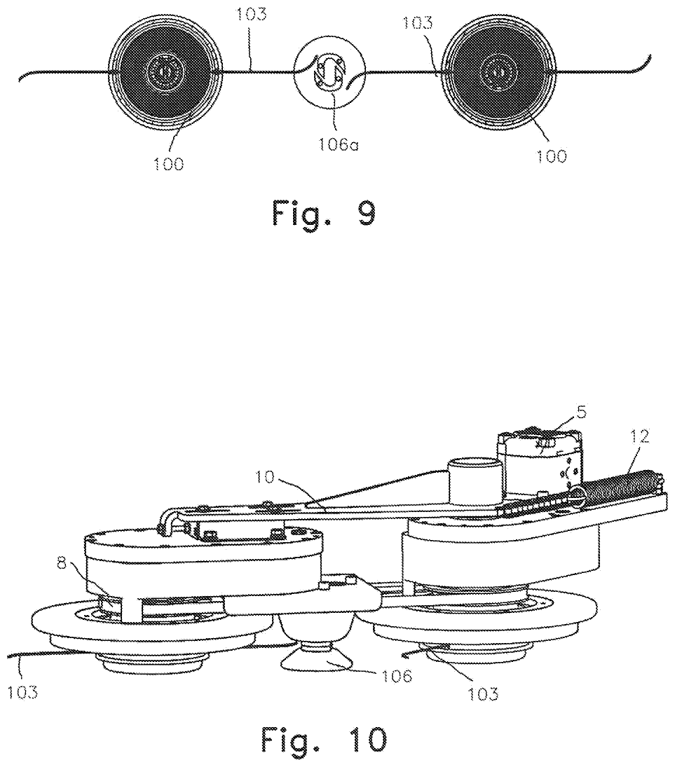

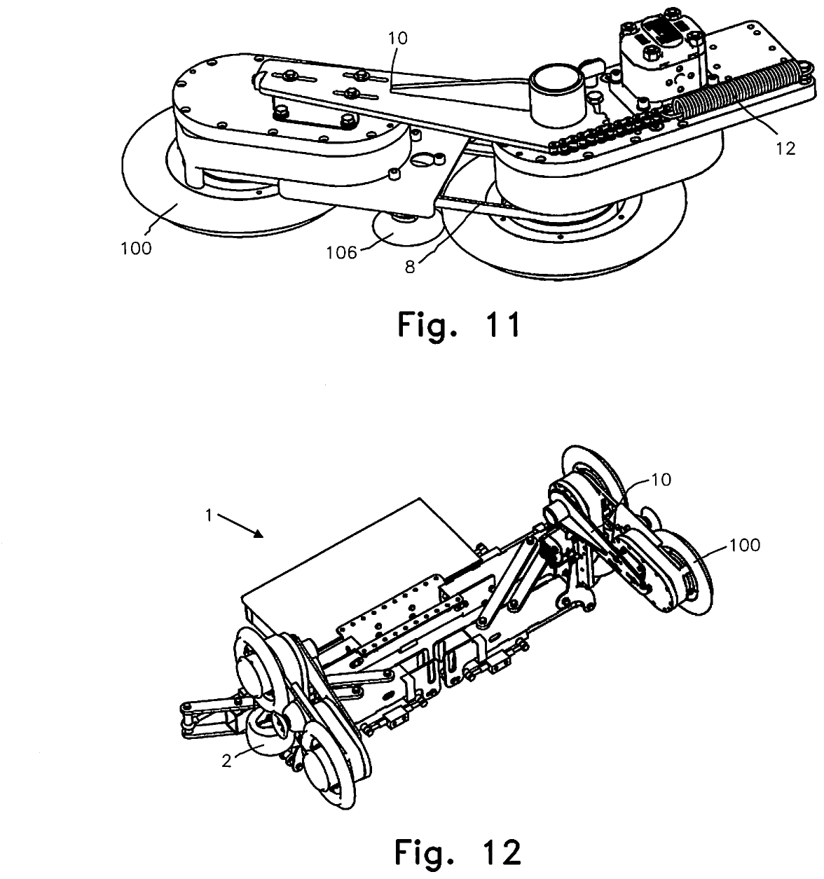

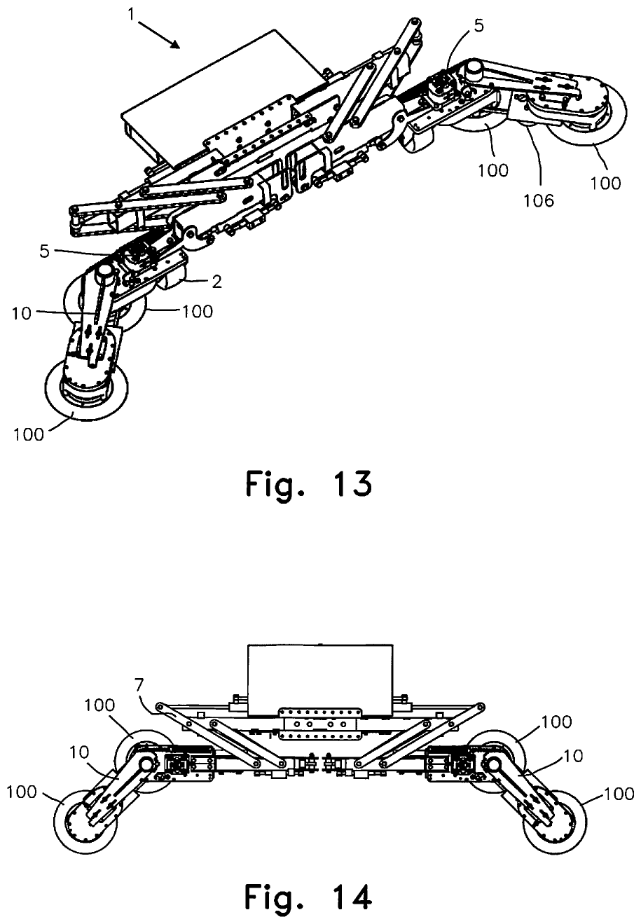

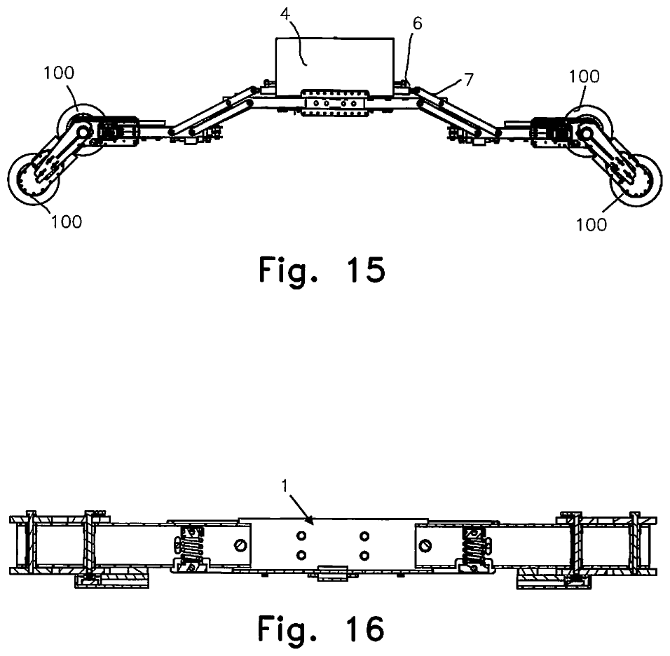

FIG. 9 shows the cutting device 106 in a preferred embodiment. In this device, two knives 106a are arranged with a U-shaped cross-section, in which the opening of the U is oriented against the direction of rotation of the thread 103. Advantageously, the cutting device 106 comprises suction means. In this way, all the cut off thread is sucked and collected, because of the small size with the speed of the thread and due to the small size of the cut off thread parts, there is a risk of deflection and therefore environmental pollution. With a suction device arranged in or near the cutting device, all and/or most of the thread parts are collected.

A suction tube can easily be arranged in the vicinity of the cutting device.

Two trimming rotors 100 driven by a single drive 5 are preferably connected to one another so as to be rotatable about an axis which is essentially parallel to the axis of rotation of the trimming rotor 100. The connection can be made via an arm 10. To control the position, a control piston 110 can be arranged between the first trimming rotor 100 and the second trimming rotor 100, which adjusts the position between the two trimming rotors 100.

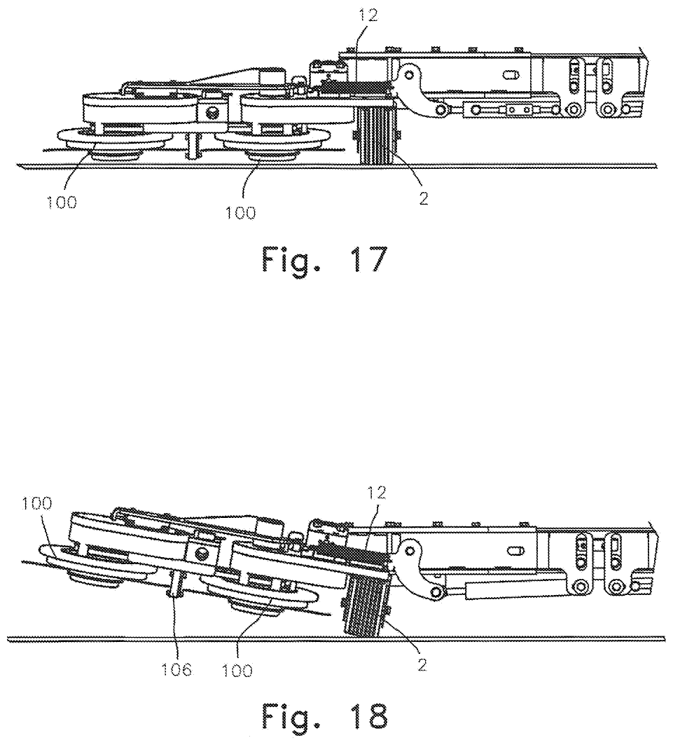

A preferred embodiment of the invention is shown in FIGS. 17 and 18, from which it can be seen that the height of the wheels 2 can be adjusted and/or tilted relative to the terrain. In this way the cutting height can be adjusted and/or the device according to the invention can also be used to make a cut on tilted terrain.

In a preferred embodiment, the connection between the first and second rotors 100 can be regulated by means of a spring 12 and a chain. In this way, if the second rotor hits an obstacle, it will retract and then return to position after overcoming the obstacle. This system may also be combined with a control piston 110.

### REFERENCE NUMBERS

1 Device

2 Wheels

3 Joint

4 Frame

5 Drive

6 Piston system

7 Joints

8 Belt

10 Arm

12 Spring

100 Trimming rotor

101 Housing

102 Opening

103 Thread

105 Receptacle

106 Cutting device

107 Shaft

110 Control piston

1. A trimmer mower rotor, formed by a receptacle on which at least one plastic thread is wound, wherein the receptacle being rotatably accommodated in a housing and the receptacle and the housing are rotatable around a single axis, wherein the housing has at least one opening through which the at least one plastic thread is guided to the outside, wherein the receptacle and at least one part forming the housing having the at least one opening are driven at different speeds and rotate at different speeds and the receptacle rotates at a speed greater than that of the portion of the housing having the at least one opening in a direction opposite to the winding direction of the at least one plastic thread on the receptacle.

2. The trimmer mower rotor according to claim 1, wherein the receptacle and at least one part forming the housing are driven by a single drive, with the interposition of a transmission.

3. The trimmer mower rotor according to claim 1, wherein the housing a circular cross-section and at least two openings which face away from each another.

4. The trimmer mower rotor according to claim 1, wherein the housing which has the at least one opening through which the at least one plastic thread is guided rotates at 1-10 revolutions faster.

5. The trimmer mower rotor according to claim 1, wherein the unwinding speed of the plastic thread can be adjusted during trimming.

6. A trimming device towed by a machine, comprising at least two trimming rotors according to claim 1.

7. The trimming device according to claim 6, wherein the trimming device has at least two trimming rotors on each side of the machine.

8. The trimming device according to claim 6, wherein the width of the trimming device is adjustable.

9. The trimming device according to claim 6, wherein the trimming device includes a cutting device for cutting the plastic thread.

10. The trimming device according to claim 9, wherein the cutting device is located between two trimming rotors and the cutting device includes a suction/collecting device.

11. (canceled)
